(19) United States
(12) Patent Application Publication
(10) Pub. No.: US 2021/0310098 A1
(43) Pub. Date: Oct. 7, 2021

(54) Method for Recovering Gold, Silver and Platinum Metals from Components of a Fuel Cell Stack or of an Electrolyzer

(71) Applicant: Robert Bosch GmbH, Stuttgart (DE)

(72) Inventors: Torsten Trossmann, Ludwigsburg (DE); Claudio Baldizzone, Stuttgart (DE)

(21) Appl. No.: 17/054,725

(22) PCT Filed: May 7, 2019
(86) PCT No.: PCT/EP2019/061630

§ 371 Date: Nov. 11, 2020

(30) Foreign Application Priority Data
May 16, 2018 (DE) 10 2018 207 589.1

(51) Int. Cl. C22B 11/02; C22B 7/00; H01M 8/008

(52) U.S. Cl. CPC C22B 11/026; H01M 8/008; C22B 7/001

(57) ABSTRACT

A method for recovering gold, silver, and/or platinum from components of a fuel cell stack of a fuel cell or electrolyzer includes treating the components with an aqueous electrolyte solution and with at least one gaseous oxidant in the fuel cell or the electrolyzer in an oxidation step. In a reduction step, the components are treated with a flow of an aqueous electrolyte solution and with at least one gaseous reductant in the fuel cell or the electrolyzer. A device by which the method can be carried out has a reservoir for the electrolyte solution, a line connected to an outlet opening of the reservoir, the line having a pump, an anode inlet connection connected to an anode inlet, and a cathode inlet connection connected to a cathode inlet. An oxidant-introducer introduces a gaseous oxidant into the line. A reductant-introducer introduces a gaseous reductant and/or inert gas into the line.

The present invention relates to a process for recovering gold and/or silver and/or at least one platinum metal from constituents of a fuel cell stack of a fuel cell or of an electrolyzer. The present invention further relates to an apparatus for recovering gold and/or silver and/or a least one platinum metal from constituents of a fuel cell stack of a fuel cell or of an electrolyzer, which apparatus is suitable for carrying out the process.

### PRIOR ART

Fuel cell stacks of a fuel cell and electrolyzers require gold, silver and platinum metals such as platinum, palladium, ruthenium and iridium as essential raw materials. The recovery of these from the fuel cell stacks or electrolyzers can be carried out pyrometallurgically or hydrometallurgically. Pyrometallurgical recovery is carried out by pyrolyzing the entire fuel cell. The noble metal-rich ash obtained can then be worked up by various processes. However, this is very energy-intensive and associated with the formation of toxic emissions.

In hydrometallurgical recovery, the fuel cell stacks are removed from the fuel cells. The metals to be recovered are then brought into an aqueous solution by complexation. Hydrometallurgical processes are generally carried out at very high or very low pH values, i.e. using aggressive acids or alkalis. The complex formers used are frequently toxic, so that these processes also lead to dangerous emissions. For example, the use of aqua regia at high temperatures leads to dangerous nitrogen oxide emissions.

In the article N. Hodnik, C. Baldizzone “Platinum recycling going green via induced surface potential alteration enabling fast and efficient dissolution”, 2016, Nature Communications, Vol. 7, a description is given of how platinum and palladium can be recovered from an industrial catalyst using chloride as complex former at a pH of 1. The recovery of ruthenium and iridium using chloride as complex former can be carried out in the pH range from 13 to 14. Here, an oxidant and a reducing agent are used alternately.

### DISCLOSURE OF THE INVENTION

The process serves to recover gold and/or silver and/or at least one platinum metal from constituents of a fuel cell stack of a fuel cell or of an electrolyzer in order to allow recycling of these materials. The term platinum metals (platinum group metals; PGM) is used here to refer to the light platinum metals ruthenium, rhodium and palladium and the heavy platinum metal osmium, iridium and platinum. The process can have a plurality of steps, but comprises at least one oxidation step and one reduction step. In the oxidation step, the constituents in the fuel cell or the electrolyzer are treated with a stream of an aqueous electrolyte solution and they are treated with at least one gaseous oxidant. In one embodiment of the process, this can occur by the constituents firstly being treated with the gas and then being brought into contact with the electrolyte solution. In another embodiment of the process, the at least one gaseous oxidant is introduced into the electrolyte solution before the latter is brought into contact with the constituents. The gaseous oxidant can be, in particular, ozone.

The oxidant brings about transient dissolution of gold and/or silver and/or at least one platinum metal from the constituents whose metal cations are complexed in the electrolyte solution. As complex formers, preference is given to using chloride anions, bromide anions and/or iodide anions which are present as, in particular, alkali metal chlorides, alkali metal bromides and/or alkali metal iodides in the electrolyte solution. These form halide complexes with the metal cations.

The pH of the electrolyte solution is preferably in the range from more than 0 to less than 14. It is thus necessary to work only with dilute acids and alkalis, which makes the process safer than conventional processes. Suitable acids for setting a pH of less than 7 are, in particular, the strong acids hydrochloric acid (HCl), perchloric acid (HClO₄), sulfuric acid (H₂SO₄) and nitric acid (HNO₃). Suitable alkalis for setting a pH of more than 7 are, in particular, the strong alkalis sodium hydroxide (NaOH) and potassium hydroxide (KOH).

In the reduction step, the constituents in the fuel cell or the electrolyzer are treated with a stream of an aqueous electrolyte solution and they are treated with at least one gaseous oxidant. This can, in one embodiment of the process, occur by the constituents firstly being treated with gas and then being brought into contact with the electrolyte solution. In another embodiment of the process, the at least one gaseous reducing agent is introduced into the electrolyte solution before the latter is brought into contact with the constituents. The reducing agent is, in particular, hydrogen or a mixture of hydrogen and carbon monoxide. The presence of some reducing agents can lead, depending on the redox potential thereof, to precipitation of the complexed metals, but has positive effects which outweigh this disadvantage. Firstly, the surface of the starting materials is reduced and thus freed of, for example, surface oxides, so that the metals go over into solution easily. In addition, transient dissolution of metals, in particular of platinum, ruthenium and iridium, can occur. This makes the freshly created metal surface accessible to further reaction with the oxidant. If a halogen is produced by reaction between the oxidant and halide ions of the electrolyte solution, this can be reduced again to a halide by a reaction between the halogen and the reducing agent. The oxidation step and the reduction step can alternate a number of times in the process.

To ensure that there is no longer any oxidant in the fuel cell when the reduction step commences or that there is no longer any reducing agent in the fuel cell when the oxidation step commences, a flushing step is preferably provided between the oxidation step and the reduction step. In the flushing step, the constituents are treated with at least one inert gas, for example nitrogen or a noble gas. The inert gas can either be passed directly over the constituents or it can be introduced into the stream of an aqueous electrolyte solution which is brought into contact with the constituents.

Preference is given to using the same electrolyte solution in the oxidation step, in the reduction step and in the flushing step. In embodiments of the process in which the gases are introduced into the electrolyte solution, only a change in the gas introduced into the electrolyte solution, i.e. between the oxidant, the reducing agent and the inert gas, takes place in the different steps. In embodiments of the process in which the constituents are alternately treated with gases and with the electrolyte solution, a change in the gas likewise takes place, while the same electrolyte solution is always used. This makes a simple process procedure possible.

In one embodiment of the process, the electrolyte solution is conveyed from at least one stock vessel to the constituents. Here, it can be admixed with the oxidant, the reducing agent or the inert gas downstream of the stock vessel. After contact with the constituents, the electrolyte solution is collected in a collection vessel. If oxidant and reducing agent from the oxidation step and the reduction step which have not reacted with the constituents are still present in the electrolyte solution, these react with one another at the latest in the collection vessel. After the recovery of the metals from the constituents is concluded, the metals can be precipitated from the solution present in the collection vessel by, for example, reducing them by introduction of hydrogen as reducing agent. The precipitate metals are then collected for further processing.

In another embodiment of the process, a continuous process procedure is provided. Here, the electrolyte solution is conveyed in a circuit in which it is brought into contact with the constituents a number of times. Before renewed introduction of the electrolyte solution into the fuel cell, it is admixed with the gas required in the respective reaction step, i.e. the oxidant, the reducing agent or the inert gas. After the metal recovery is complete, the electrolyte solution is drained from the circuit and worked up in the same way as the contents of the collection vessel in the batchwise embodiment of the process.

While some metals form soluble metal complexes only in acidic solution, other metals form soluble metal complexes only in alkaline solution. Thus, ruthenium, for example, forms soluble complexes at a pH of more than 7, while platinum forms soluble hexachloroplatinate(IV) complexes at a pH of less than 7. To be able to recover all metals at which this process is directed from the constituents of the fuel cell stack or of an electrolyzer, preference is therefore given to the constituents being treated with an electrolyte solution having a pH of more than 7 in a first part of the process. In a second part of the process, they are then treated with an electrolyte solution having a pH of less than 7. The terms “first part” and “second part” should not be understood as being a restriction in respect of the order in which the parts of the process can be carried out. It is also possible firstly to carry out the second part using the pH of less than 7 and then carry out the first part using the pH of greater than 7.

The apparatus for recovering gold and/or silver and/or at least one platinum metal from constituents of a fuel cell stack of a fuel cell or of an electrolyzer comprises at least one stock vessel for an electrolyte solution. When the apparatus has a plurality of stock vessels, these can be provided for feeding the same electrolyte solution into a conduit system of the apparatus at different places or they can contain electrolyte solutions having different pH values.

A first conduit is connected to an outlet opening of the at least one stock vessel. It has an anode inlet connection which is connected to an anode inlet of a fuel cell or of an electrolyzer. Furthermore, it has a cathode inlet connection which is connected to an anode inlet of a fuel cell or of an electrolyzer. At least one oxidant feed conduit is configured for introducing at least one gaseous oxidant into the first conduit. At least one reducing agent feed conduit is configured for introducing at least one gaseous reducing agent and/or inert gas into the first conduit. The first conduit can have a single branch or multiple branches and have valves in order to control the flow of an electrolyte solution from the stock vessel and/or of a gas stream through the first conduit. Furthermore, at least one first pump which is arranged in the first conduit is provided for transporting the electrolyte solution. The apparatus can be connected via the anode inlet connection and the cathode inlet connection to the anode inlet and the cathode inlet of a fuel cell in order to introduce an electrolyte solution from the stock vessel into the fuel cell.

The apparatus is suitable for carrying out the process. In the oxidation step of the process, gaseous oxidant can be introduced into the stream of the electrolyte solution by means of the at least one oxidant feed conduit. As an alternative, firstly a gaseous oxidant and then the electrolyte solution can be conveyed through the first conduit in the oxidation step by suitable switching of valves. In the reduction step, gaseous reducing agent can be introduced by means of the reducing agent feed conduit into the stream of the electrolyte solution. As an alternative, firstly a gaseous reducing agent and then the electrolyte solution can be conveyed through the first conduit in the reduction step by suitable switching of valves. In the flushing step, the inert gas can be introduced via the reducing agent feed conduit into the stream of the electrolyte solution. As an alternative, only the inert gas can be conveyed through the first conduit in the flushing step. When a plurality of reducing agent feed conduits are present, it is also possible for one reducing agent feed conduit to be used exclusively for the gaseous reducing agent or another reducing agent feed conduit to be used exclusively for the inert gas. The apparatus makes it possible to recover gold and/or silver and/or at least one platinum metal from the constituents of the fuel cell stack or of an electrolyzer without the fuel cell having to be dismantled for this purpose. Rather, the chemicals required for the recovery are introduced into the fuel cell using the connections which are in any case present in the fuel cell.

To drain the electrolyte solution from the fuel cell, various embodiments of the apparatus are provided in each case with a second conduit which has an anode outlet connection which is connected to an anode outlet of the fuel cell or of the electrolyzer. Furthermore, it has a cathode outlet connection which is connected to a cathode outlet of the fuel cell or of the electrolyzer. Like the first conduit, the second conduit can also have one or more branches and have valves in order to control the flow of the electrolyte solution.

In one embodiment of the apparatus, the apparatus additionally has a collection vessel for the electrolyte solution which is connected to the second conduit. This embodiment of the apparatus allows a discontinuous process procedure.

In a further embodiment of the apparatus, the second conduit is connected to the first conduit upstream of the oxidant feed conduit and the reducing agent feed conduit. This embodiment of the apparatus allows a continuous process procedure in which the electrolyte solution is firstly fed from the stock vessel into the first conduit and subsequently conveyed in the circuit by means of the first conduit and the second conduit.

In still another embodiment of the apparatus, the second conduit is connected to an inlet opening of the stock vessel. This embodiment of the apparatus also allows a continuous process procedure. However, electrolyte solution which leaves the fuel cell is in this case not fed directly into the first conduit but instead it flows into the stock vessel and mixes with the electrolyte solution kept in stock there.

When ozone is used as oxidant, it has to be generated in the apparatus because of its short life. In one embodiment of the apparatus, the apparatus comprises an electrochemical ozonizer having an ozone outlet and a hydrogen outlet. Here, the ozone outlet functions as oxidant feed conduit and the hydrogen outlet functions as reducing agent feed conduit. In this way, hydrogen which can function as reducing agent in the process can also be produced in the apparatus.

### BRIEF DESCRIPTION OF THE DRAWINGS

Working examples of the invention are presented in the drawings and will be described in more detail in the following description.

FIG. 1 schematically shows an apparatus for recovering gold and/or silver and/or at least one platinum metal as per one working example of the invention.

FIG. 2 schematically shows an apparatus for recovering gold and/or silver and/or at least one platinum metal as per another working example of the invention.

FIG. 3 schematically shows an apparatus for recovering gold and/or silver and/or at least one platinum metal as per still another working example of the invention.

FIG. 4 schematically shows an apparatus for recovering gold and/or silver and/or at least one platinum metal as per still another working example of the invention.

FIG. 5 schematically shows an apparatus for recovering gold and/or silver and/or at least one platinum metal as per still another working example of the invention.

FIG. 6 schematically shows an apparatus for recovering gold and/or silver and/or at least one platinum metal as per still another working example of the invention.

### WORKING EXAMPLES OF THE INVENTION

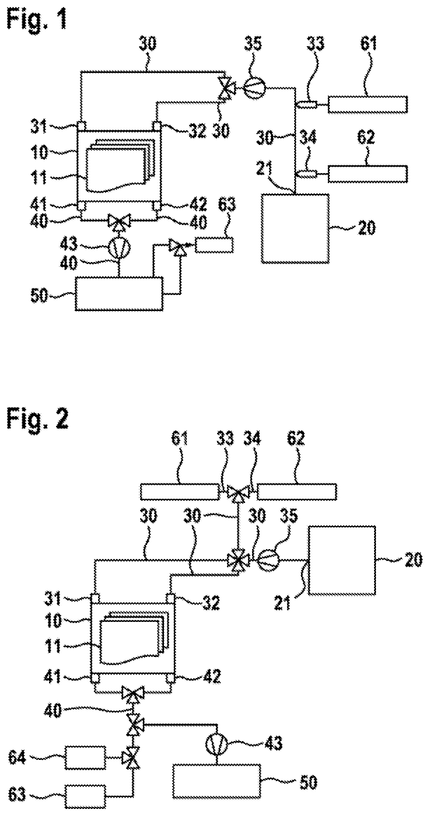

FIG. 1 depicts a fuel cell 10 which is connected to an apparatus as per a first working example of the invention. The fuel cell 10 contains a fuel cell stack 11. This contains ruthenium and platinum as catalyst materials on carbon as support material. An aqueous electrolyte solution containing 0.1 M NaOH and 3 M NaCl is kept in stock in a stock vessel 20. This electrolyte solution has a pH of 13. The stock vessel 20 is connected via an outlet opening 21 to a first conduit 30. The first conduit 30 branches to form an anode inlet connection 31 and a cathode inlet connection 32 at the fuel cell 10. Before the branching point, an oxidant feed conduit 33 and a reducing agent feed conduit 34, which are each configured as a Venturi nozzle, are arranged on the first conduit 30. Downstream of the oxidant feed conduit 33 and the reducing agent feed conduit 34, a pump 35 is arranged in the first conduit 30 upstream of the branching point in order to convey the electrolyte solution through the first conduit 30. A second conduit 40 is connected to an anode outlet connection 41 and a cathode outlet connection 42 on the fuel cell 10. Two subsections of this second conduit 40, which go out from the fuel cell 10, combine to form a joint conduit in which a second pump 43 is arranged. This second pump 43 conveys the electrolyte solution introduced by means of the first pump 35 into the fuel cell 10 out from the fuel cell again and conveys it into a collection vessel 50. The oxidant feed conduit 33 is connected to an ozonizer 61 which produces a mixture of oxygen and ozone by means of the corona effect. The reducing agent feed conduit 34 is connected to a gas conduit 62 through which hydrogen, carbon monoxide, nitrogen or mixtures of these gases can be introduced as desired. The collection vessel 50 is connected via further conduits to an ozone decomposer 63 in order to decompose ozone which has gone into the stock vessel 50 and exits from the latter.

In one working example of the process of the invention, electrolyte solution is introduced into the fuel cell 10 and is admixed with ozone by means of the oxidant feed conduit 33 in a first oxidation step. Here, surface oxidation of platinum and ruthenium takes place in the fuel cell stack 11. Since chloro complexes of platinum are not stable in aqueous solution above a pH of 7, no platinum goes into solution. However, transient dissolution of ruthenium takes place. After a compact oxide layer has been formed on the surface of the metals, the dissolution stops. The introduction of the electrolyte solution is now continued in a flushing step, but this electrolyte solution is no longer admixed with ozone but instead is admixed with nitrogen by means of the reducing agent feed conduit 34. After the unreacted ozone has been flushed from the fuel cell 10 by means of this inert gas, the stream of electrolyte solution is admixed with hydrogen via the reducing agent feed conduit 34 in a reduction step. Here, the oxide layer in the fuel cell stack 11 is reduced, with further ruthenium going into solution. As soon as all oxides have been reduced, a further flushing step in which nitrogen is fed into the stream of the electrolyte solution is carried out in order to remove unreacted hydrogen from the fuel cell 10. The reaction steps commencing with the oxidation step are then repeated until all of the ruthenium has been dissolved. A measuring unit, which is not shown, is arranged in the second conduit 40 or in the collection vessel 50 so as to be able to monitor the concentration of ruthenium complexes in the stream of electrolyte solution in order to control the change between the individual reaction steps. After dissolution of all of the ruthenium, the ruthenium solution collected in the collection vessel 50 is taken off from the latter.

The electrolyte solution in the stock vessel 20 is now replaced by an aqueous solution of 0.3 M HCl and 3 M NaCl. This has a pH of about 0.5. The sequence of oxidation step, flushing step, reduction step and renewed flushing step carried out previously using the first electrolyte solution is now repeated using this new electrolyte solution. However, the electrolyte solution is admixed not with pure hydrogen but with a mixture of 90% by weight of hydrogen and 10% by weight of carbon monoxide in the reduction step. At this pH, platinum now forms stable H₂PtCl₆ and can thus be transiently dissolved by oxidation of the platinum surface and subsequent reduction of the oxides. Here, the carbon monoxide added in the reduction step adsorbs on the platinum surface and thus prevents precipitation of platinum in the reduction step. The dissolution process of the platinum is also monitored by means of the measurement unit (not shown). As soon as all the platinum has been dissolved, the platinum solution is taken off from the collection vessel 50. The two metal solutions can now be worked up by precipitation of the respective metals by means of introduction of hydrogen.

A second working example of the apparatus is depicted in FIG. 2. In this working example, the oxidant feed conduit 33 and the reducing agent feed conduit 34 are not arranged between the stock vessel 20 and the first pump 35. Instead, a further subconduit branches off at the branching point of the first conduit 30 and both the oxidant feed conduit 33 and the reducing agent feed conduit 34 open into the end of this further subconduit. In this working example of the apparatus, these are not configured as Venturi nozzles but instead as valves. The subconduit of the first conduit 30 between the branching point and the oxidant feed conduit 33 or the reducing agent feed conduit 34 in this case does not serve to transport the electrolyte solution but instead exclusively to transport gas. Furthermore, the ozone decomposer 63 is not arranged downstream of the collection vessel 50 in this working example. Instead, the second conduit 40 branches a number of times before the second pump 43 and leads to the ozone decomposer 63 and an outlet conduit 64. When using this apparatus, the electrolyte solution is not already admixed with the gas required for the oxidation step, reduction step or flushing step before introduction into the fuel cell 10. Instead, ozone is firstly introduced into the fuel cell 10 in the oxidation step without introduction of the electrolyte solution, with unreacted ozone going into the ozone decomposer 63. Valves prevent gaseous ozone from getting to the outlet conduit 64 or into the pump 43. The aqueous electrolyte solution is then passed through the fuel cell 10 in order to take up metal ions. It is then conveyed by means of valves through the second pump 43 into the collection vessel 50. This is followed by a flushing step in which nitrogen is conveyed through the fuel cell 10 and leaves the apparatus through the outlet conduit 64. In the reduction step, hydrogen (for reducing ruthenium oxides) or the hydrogen/carbon monoxide mixture (for reducing platinum oxides) is conveyed through the fuel cell 10 and likewise leaves the apparatus through the outlet conduit 64, and further electrolyte solution is then introduced into the fuel cell 10 in order to complex metal ions and convey these into the collection vessel 50. The second flushing step is once again carried out without use of the electrolyte solution only by introduction of nitrogen, after which an oxidation step can be commenced again. The change between the different electrolyte solutions and the work-up of the metal solutions is carried out in the same way as when using the apparatus as per the first working example of the invention.

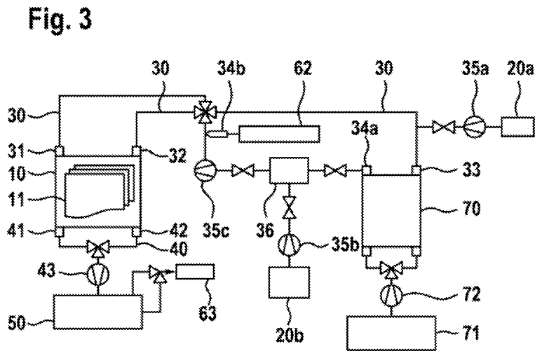

A third working example of the apparatus, which is depicted in FIG. 3, provides for ozone and hydrogen to be produced by means of an electrochemical ozonizer 70. This is supplied with distilled water from a water tank 71; this water is fed by means of a third pump 72 into the electrochemical ozonizer 70. In the oxidation step, ozone is conveyed from the ozone outlet of the electrochemical ozonizer 70, which functions as oxidant feed conduit 33, through the first conduit 30 into the fuel cell 10. Electrolyte solution is subsequently conveyed from the first stock vessel 20a and the associated first pump 35a through the fuel cell 10. The generation of ozone at the same time forms a mixture of hydrogen and water vapor. This is conveyed through the hydrogen outlet of the electrochemical ozonizer 70, which functions as reducing agent feed conduit 34a, into a tank 36 and collected there. In the reduction step, the hydrogen/water mixture is firstly conveyed from the tank 36 into the fuel cell 10 and electrolyte solution is subsequently conveyed from a second stock vessel 20b by means of the associated first pump 35b into the fuel cell 10. A further first pump 35c is arranged in the first conduit 30 in such a way that it can transport the water/hydrogen mixture. Downstream of this first pump 35c, there is also a further reducing agent inlet 34b which is configured as a Venturi nozzle. Carbon monoxide can be introduced by means of this reducing agent inlet 34b into the water/hydrogen mixture in the reduction step, or nitrogen can be introduced into the stream of the electrolyte solution from the second stock vessel 20b in the flushing step. When using this apparatus, the flushing step is carried out only after the reduction step and before the next oxidation step, but not after the oxidation step and before the following reduction step. As regards the use of different electrolyte solutions and the work-up of the metal solutions, the procedure as in the preceding working examples is employed.

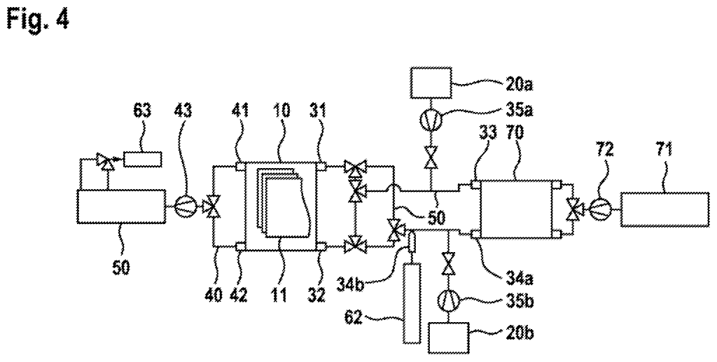

FIG. 4 shows a fourth working example of the apparatus. This makes continuous operation of the electrochemical ozonizer 70 possible. The hydrogen/water mixture, which in the reduction of platinum oxides is additionally admixed with carbon monoxide, is here conveyed by suitable switching of valves in the first conduit 30 either through the anode inlet connection 31 or through the cathode inlet connection 32 into the fuel cell 10. At the same time, ozone is introduced into the fuel cell 10 through the other of the two connections 31, 32. Both the ozone and the reducing gases are mixed with electrolyte solution from two stock vessels 20a, 20b before they go into the fuel cell 10. Switching of the valves enables the oxidation step or the reduction step to be carried out alternately at the cathode and the anode. Here, the solutions from the oxidation at the one electrode and the reduction at the other electrode combine in the second conduit 40. The flushing steps are carried out simultaneously at the two electrodes, with the valves in the first conduit 30 being set so that an electrolyte solution from the second stock vessel 20b is admixed with nitrogen from the further reducing agent feed conduit 34b and is then conveyed to the anode inlet connection 31 and simultaneously to the cathode inlet connection 32. During the flushing steps, the electrochemical ozonizer 70 is switched off.

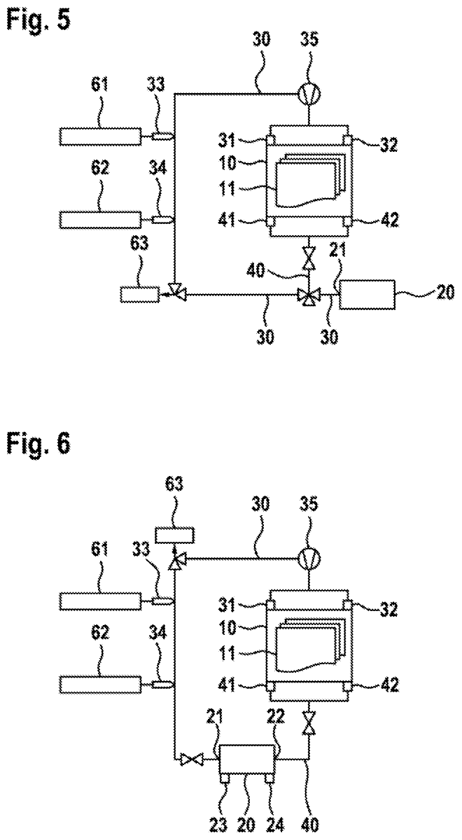

An apparatus as per the fifth working example of the invention is depicted in FIG. 5. This is designed to convey the electrolyte solution through the circuit a number of times. For this purpose, it is fed from a stock vessel 20 into the first conduit 30 and passed through the fuel cell 10. Through the second conduit 40, it is subsequently recirculated at a branching point of the first conduit 30 and the second conduit 40 into the first conduit 30. Downstream of this branching point, it can, depending on the process step, it can be admixed with ozone, nitrogen or hydrogen or a hydrogen/carbon monoxide mixture through the oxidant feed conduit 33 or the reducing agent feed conduit 34. When it has taken up all of a dissolved metal, the electrolyte solution can be pumped back into the stock vessel 20 and taken off from this by suitable switching of valves. A new electrolyte solution having a different pH is subsequently introduced.

In a sixth working example of the invention, a further apparatus as depicted in FIG. 6 is provided. This too allows the electrolyte solution to be conveyed continuously in a circuit. However, the stock vessel 20 is arranged so that its outlet opening 21 is connected to the first conduit and its inlet opening 22 is connected to the second conduit and it thus forms part of the circuit. The measuring unit 23 for determining the metal content of the electrolyte solution, which is not shown in the other working examples, is arranged in the stock vessel 20 in this working example. As soon as the recovery of a metal is concluded, a valve at the outlet opening 21 of the stock vessel 20 is closed and the entire electrolyte solution is pumped back into the stock vessel 20 and taken off from the latter via an offtake opening 24. The stock vessel 20 is then filled with a different electrolyte solution in the same way as in the fifth working example of the invention.

1. A process for recovering at least one of gold, silver, and platinum metal from constituents of a fuel cell stack of a fuel cell or of an electrolyzer, the method comprising:
oxidizing the constituents by treating the constituents with a first stream of a first aqueous electrolyte solution and with at least one gaseous oxidant in the fuel cell or the electrolyzer; and
reducing the constituents by treating the constituents with a second stream of a second aqueous electrolyte solution and with at least one gaseous reducing agent in the fuel cell or the electrolyzer.

2. The process as claimed in claim 1, further comprising:
flushing the constituents between the oxidizing and the reducing by treating the constituents with at least one inert gas.

3. The process as claimed in claim 2, wherein the first and second aqueous electrolyte solutions are the same electrolyte solution, and the flushing includes using the same electrolyte solution.

4. The process as claimed in claim 1, wherein the first and second electrolyte solutions are conveyed from at least one stock vessel to the constituents and, after contact with the constituents, the first and second electrolyte solutions are collected in a collection vessel.

5. The process as claimed in claim 1, wherein the first and second electrolyte solutions are conveyed in a circuit in which the first and second electrolyte solutions are brought into contact with the constituents a number of times.

6. The process as claimed in claim 1, wherein the first and second electrolyte solutions include at least one alkali metal chloride, alkali metal bromide, and/or alkali metal iodide.

7. The process as claimed in claim 1, further comprising:
a first part, including the oxidizing and reducing, in which the constituents are treated with the first and second electrolyte solutions having a pH of greater than 7; and
a second part in which the constituents are treated with a third electrolyte solution having a pH of less than 7.

8. An apparatus for recovering at least one of gold, silver, and platinum metal from constituents of a fuel cell stack of a fuel cell or electrolyzer, comprising:
at least one stock vessel for an electrolyte solution, the at least one stock vessel including an outlet opening;
a first conduit which is connected to the outlet opening, the first conduit including an anode inlet connection connected to an anode inlet of the fuel cell or electrolyzer and a cathode inlet connection connected to a cathode inlet of the fuel cell or electrolyzer;
at least one oxidant feed conduit configured for introducing at least one gaseous oxidant into the first conduit;
at least one reducing agent feed conduit configured for introducing at least one gaseous reducing agent and/or inert gas into the first conduit; and
at least one first pump arranged in the first conduit.

9. The apparatus as claimed in claim 8, further comprising:
a second conduit including an anode outlet connection and a cathode outlet connection for the fuel cell;
a collection vessel for the electrolyte solution, the collection vessel connected to the second conduit; and
at least one second pump arranged in the second conduit.

10. The apparatus as claimed in claim 8, further comprising:
a second conduit including an anode outlet connection connected to an anode outlet of the fuel cell or electrolyzer and a cathode outlet connection connected to a cathode outlet of the fuel cell or electrolyzer and is connected to the first conduit upstream of the at least one oxidant feed conduit and the at least one reducing agent feed conduit.

11. The apparatus as claimed in claim 8, further comprising:
a second conduit including an anode outlet connection connected to an anode outlet of the fuel cell or electrolyzer and a cathode outlet connection connected to a cathode outlet of the fuel cell or electrolyzer, the cathode outlet connection connected to an inlet opening of the stock vessel.

12. The apparatus as claimed in claim 8, further comprising:
an electrochemical ozonizer having an ozone outlet and a hydrogen outlet,
wherein the ozone outlet functions as the at least one oxidant feed conduit and the hydrogen outlet functions as the at least one reducing agent feed conduit.
